(19) United States
(12) Patent Application Publication
(10) Pub. No.: US 2026/0334457 A1
(43) Pub. Date: Oct. 29, 2026

(54) ANIMATED WATERFOWL DECOY SYSTEM, METHOD AND APPARATUS

(71) Applicant: Jon Michael Koregelos, Williams, CA (US)

(72) Inventor: Jon Michael Koregelos, Williams, CA (US)

(21) Appl. No.: 19/413,320

(22) Filed: Dec. 9, 2025

Related U.S. Application Data
(63) Continuation-in-part of application No. 29/908,679, filed on Mar. 15, 2024.

(51) Int. Cl. A01M 31/06

(52) U.S. Cl. CPC A01M 31/06

(57) ABSTRACT

An animated waterfowl decoy system and method wherein the decoy system includes a central decoy portion with a drive mechanism and a central axis passing vertically through the central decoy portion. A first wing assembly includes a first wing axle secured to the central decoy portion at a first wing drop angle relative to the central axis, and a first wing rotatably mounted on the first wing axle, the first wing being mechanically coupled to the drive mechanism at a first drive rate. A second wing assembly is substantially the same as the first wing assembly, the second wing being mechanically coupled to the drive mechanism at a second drive rate, wherein the first drive rate is not equal to the second drive rate.

### CROSS REFERENCE TO RELATED APPLICATIONS

This application is a continuation-in-part of and claims priority from U.S. Design patent application Ser. No. 29/908,679 filed on Jan. 15, 2024 and entitled “Duck Spinner,” which is incorporated herein by reference in its entirety for all purposes.

### FIELD OF THE DISCLOSURE

The present disclosure relates generally to animal models, and more particularly, to methods and systems for animated waterfowl decoys.

### BACKGROUND

Hunting animals is a widely practiced sport and method of gathering animals for consumption, study, collection and other uses. Successful hunters identify locales where their target prey animals may be found. Animals are more likely to approach an area that is already populated by similar species animals. For example, birds such as ducks, geese, swans and other waterfowls in the anseriformes order of birds, will often land in a body of water where other similar species of waterfowls are already present. In contrast, a body of water unoccupied by a similar species of waterfowl is typically, instinctually avoided by waterfowl that maybe flying past. As a result, it is commonplace for waterfowl hunters to place one or more decoy waterfowls in a body of water to attract waterfowls that maybe passing by, while the hunters wait under nearby camouflaged cover.

Experience has shown that commonly used, unmoving, static or otherwise non-animated decoys are considerably less attractive to passing waterfowl and therefore fewer waterfowl tend to land near such decoys.

It is in this context that the following embodiments arise.

### SUMMARY

Broadly speaking, the present disclosure fills these needs by providing an animated bird decoy having lifelike appearing wing movements. It should be appreciated that the present disclosure can be implemented in numerous ways, including as a process, an apparatus, a system or a device. Several inventive embodiments of the present disclosure are described below.

One disclosed implementation provides an animated waterfowl decoy system. The animated waterfowl decoy system includes a central decoy portion which includes a drive mechanism and a central axis passing vertically through the central decoy portion. A first wing assembly and a second wing assembly are also included. The first wing assembly includes a first wing axle secured to the central decoy portion at a first wing drop angle relative to the central axis and a first wing rotatably mounted on the first wing axle, the first wing being mechanically coupled to the drive mechanism at a first drive rate. The second wing assembly includes a second wing axle secured to the central decoy portion at a second wing drop angle relative to the central axis, the second wing drop angle being adjacent to the first wing drop angle and a second wing rotatably mounted on the second wing axle, the second wing being mechanically coupled to the drive mechanism at a second drive rate, wherein the first drive rate is not equal to the second drive rate.

The first wing includes a first wing top surface and first wing bottom surface, wherein the first wing bottom surface is opposite from the first wing top surface, and the second wing includes a second wing top surface and second wing bottom surface, wherein the second wing bottom surface is opposite from the second wing top surface. In one implementation, the first wing top surface and the second wing top surface are covered in a first wing color and the first wing bottom surface and the second wing bottom surface are covered in a second wing color.

The first wing color is a substantially white or silver color or other colors that reflect most of the visible spectrum of wavelengths of light and the second wing color is a relatively dark color such as brown, black, blue dark red or dark green or a combination thereof such that the second color that absorbs most of the visible spectrum of wavelengths of light.

In at least one implementation, the drive mechanism can be electrically powered.

In another implementation, the drive mechanism can be hydraulically powered. The hydraulically powered drive mechanism can include a first hydraulic jet aimed at the first wing, the first hydraulic jet being sized to spray a first hydraulic flow rate of fluid toward and impending on the first wing to cause the first wing to rotate about the first wing axle at the first drive rate, and a second hydraulic jet aimed at the second wing, the second hydraulic jet being sized to spray a second hydraulic flow rate of fluid toward and impending on the second wing to cause the second wing to rotate about the second wing axle at the second drive rate.

The first wing drop angle can be between 25 and 85 degrees and the second wing drop angle can be between 25 and 85 degrees. The first wing drop angle and the second wing drop angle may be equal or, alternatively, may not be equal. In at least one implementation, a sum of the first wing drop angle and the second wing drop angle is less than 180 degrees.

In at least one implementation, the first wing axle can extend from a first wing top surface of the first wing, passing through a first central wing portion to a first wing bottom surface of the first wing at a first wing axle offset rotational angle relative to a first central wing portion plane. Similarly, the second wing axle can extend from a second wing top surface of the second wing, passing through a second central wing portion to a second wing bottom surface of the second wing at a second wing axle offset rotational angle relative to a second central wing portion plane. The first wing axle offset rotational angle may not be equal to the second wing axle offset rotational angle or alternatively, the first wing axle offset rotational angle may be equal to the second wing axle offset rotational angle.

In at least one implementation, the first wing and the second wing can be mechanically coupled to the drive mechanism with a belt.

The first drive rate and the second drive rate can be between 250 and 410 revolutions per minute. Alternatively, or additionally, the first drive rate can be within a selected percentage of the second drive rate. By way of example, first drive rate can be within 3 percent of the second drive rate.

Another implantation provides an animated waterfowl decoy system including a central decoy portion including a drive mechanism coupled to an external drive wheel through a drive axle, a first wing assembly and a second wing assembly. The first wing assembly including a first wing body having a first proximal wing end, a first distal wing end and a first central wing portion disposed between the first proximal wing end and the first distal wing end, a first wing axle having a first proximal end and a first distal end opposite the first proximal end, the first proximal end being secured to the central decoy portion at first wing drop angle relative to a central axis of the central decoy portion, the first proximal wing end being rotationally secured to the first wing axle adjacent to the first proximal end and the first distal wing end being rotationally secured to the first wing axle at the first distal end a first wing wheel secured to the first proximal wing end, the first wing wheel being mechanically coupled to the external drive wheel at a first drive rate. The second wing assembly including a second wing body having a second proximal wing end, a second distal wing end and a second central wing portion disposed between the second proximal wing end and the second distal wing end, a second wing wheel secured to the second proximal wing end, the second wing wheel being mechanically coupled to the external drive wheel, and a second wing axle having a second proximal end and a second distal end opposite the second proximal end, the second proximal end being secured to the central decoy portion at a second wing drop angle relative to the central axis of the central decoy portion, wherein the first wing drop angle is less than 90 degrees and the second wing drop angle is less than 90 degrees. The second proximal wing end being rotationally secured to the second wing axle adjacent to the second proximal end and the second distal wing end being rotationally secured to the second wing axle at the second distal end and a second wing wheel secured to the second proximal wing end, the second wing wheel being mechanically coupled to the external drive wheel at a second drive rate, wherein the first drive rate is not equal to the second drive rate. The first wing top surface and the second wing top surface can be covered in a first wing color and the first wing bottom surface and the second wing bottom surface can be covered in a second wing color, wherein the first wing color is a substantially white color and wherein the second wing color is a relatively dark shade of brown, black, blue and combinations thereof.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The present disclosure will be readily understood by the following detailed description in conjunction with the accompanying drawings.

FIG. 1A is an isometric view of a waterfowl decoy system, for implementing embodiments of the present disclosure.

FIG. 1B is an isometric view of an alternative waterfowl decoy system, for implementing embodiments of the present disclosure.

FIG. 2A is a front view of the waterfowl decoy system, for implementing embodiments of the present disclosure.

FIG. 2B is a rear view of the waterfowl decoy system, for implementing embodiments of the present disclosure.

FIG. 2C is a top view of the waterfowl decoy system, for implementing embodiments of the present disclosure.

FIG. 2D is a side view of the waterfowl decoy system, for implementing embodiments of the present disclosure

FIGS. 3A-3D are detail views of the wings, for implementing embodiments of the present disclosure.

FIGS. 3E-3G are detail views of the wing assemblies, for implementing embodiments of the present disclosure.

FIGS. 3H-3i are detail views of the wing, for implementing embodiments of the present disclosure.

FIG. 4A is a detail view of a drive mechanism, for implementing embodiments of the present disclosure.

FIG. 4B is a detail view of a drive mechanism, for implementing embodiments of the present disclosure.

FIG. 4C is a detail view of a drive mechanism, for implementing embodiments of the present disclosure.

FIG. 4D is a detail view of a worm drive mechanism, for implementing embodiments of the present disclosure.

FIG. 4E is a detail view of a drive mechanism, for implementing embodiments of the present disclosure.

FIG. 4F is a detail view of a drive wheel, for implementing embodiments of the present disclosure.

FIG. 5A is a detail views of a wing support block, for implementing embodiments of the present disclosure.

FIGS. 5B-5C are detail views of a wing support block, for implementing embodiments of the present disclosure.

FIGS. 5D-5F are detail views of a wing quick release button, for implementing embodiments of the present disclosure.

FIG. 6 is a detail view of a hydraulic drive mechanism, for implementing embodiments of the present disclosure.

FIG. 7 is a flowchart diagram that illustrates the method operations performed in flashing the wing assemblies of a waterfowl decoy system, for implementing embodiments of the present disclosure.

### DETAILED DESCRIPTION

Several exemplary embodiments for animated bird decoys having lifelike appearing wing movements will now be described. It will be apparent to those skilled in the art that the present disclosure may be practiced without some or all of the specific details set forth herein.

Decoys that include animations such as one or more lifelike appearing movements and that appear to be similar to natural movements of the waterfowls being hunted, typically attract more waterfowls than non-animated decoys. The present disclosure implements animated waterfowl decoys with lifelike appearing wing movements. These lifelike appearing wing movements are presented in various embodiments of rate of motion, direction of motion, sweep angle, drop angles, wing shape, color, contrast, texture, thickness, length, width and appearance, among other aspects.

The lifelike appearing wing movements can be powered by many different types of power sources including electrical, pneumatic pressure and hydraulic pressure. The lifelike appearing wing movements can be continuous or intermittent and have varying rates and directions of movement.

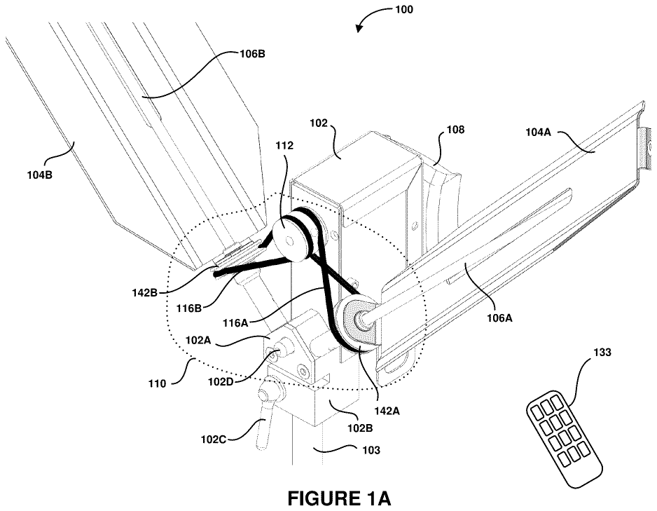

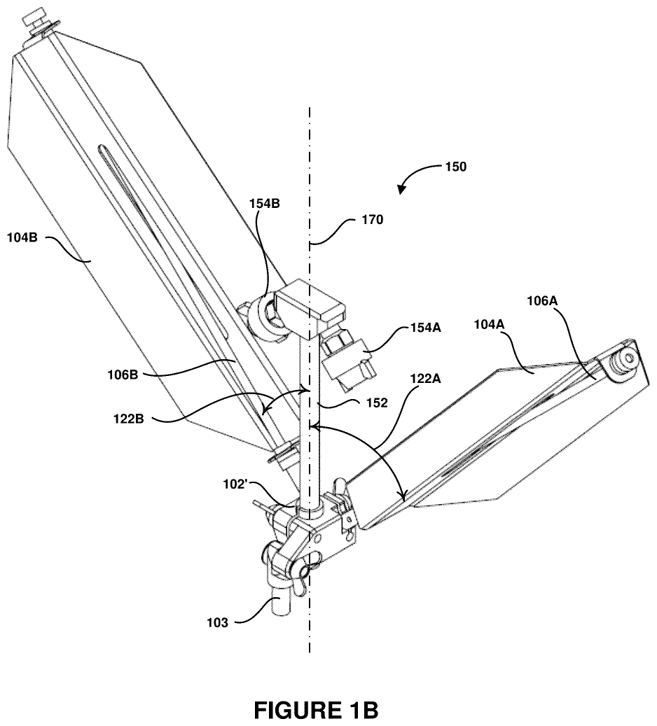

FIG. 1A is an isometric view of a waterfowl decoy system 100, for implementing embodiments of the present disclosure. The decoy system 100 includes a central decoy portion 102, a first wing 104A and a second wing 104B. The central decoy portion includes a drive mechanism 110 that is mechanically coupled to the first wing and the second wing. The drive mechanism can drive the wings rotationally around a respective first wing axle 106A and a second wing axle 106B.

The drive mechanism 110 is sized to drive the first wing to rotate about the first wing axle at a first drive rate. The drive mechanism is also sized to drive the second wing to rotate about the second wing axle at a second drive rate. In one embodiment, the first drive rate is equal to the second drive rate. In at least one embodiment, the first drive rate and the second drive rate are between about 250 and about 410 revolutions per minute. In an alternative embodiment, the first drive rate is less than the second drive rate.

In yet another embodiment, the first drive rate is within about 3 percent or less of the second drive rate. By way of an example embodiment, the first drive rate can be about 335 revolutions per minute and the second drive rate can be about 325 revolutions per minute. In another example embodiment, the first drive rate can be about 336 revolutions per minute and the second drive rate can be about 324 revolutions per minute. In another embodiment, one or both of the first drive rate and second drive rate can be varied to increase or decrease.

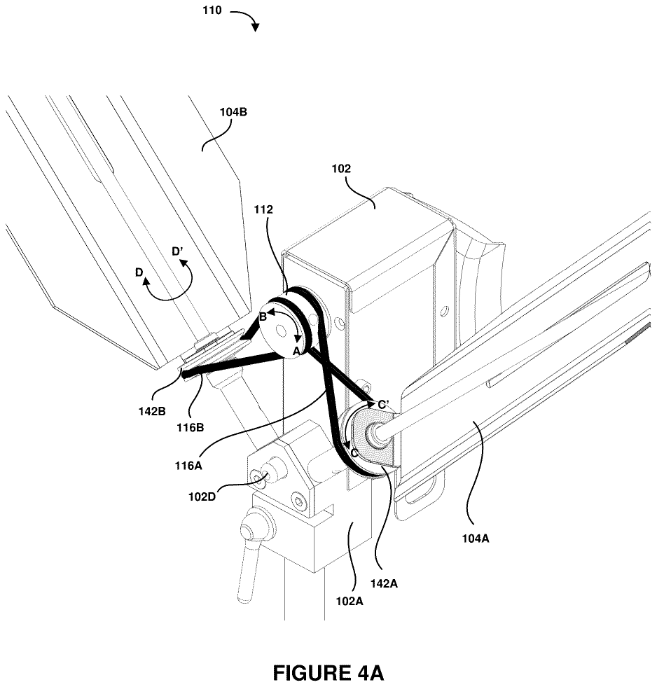

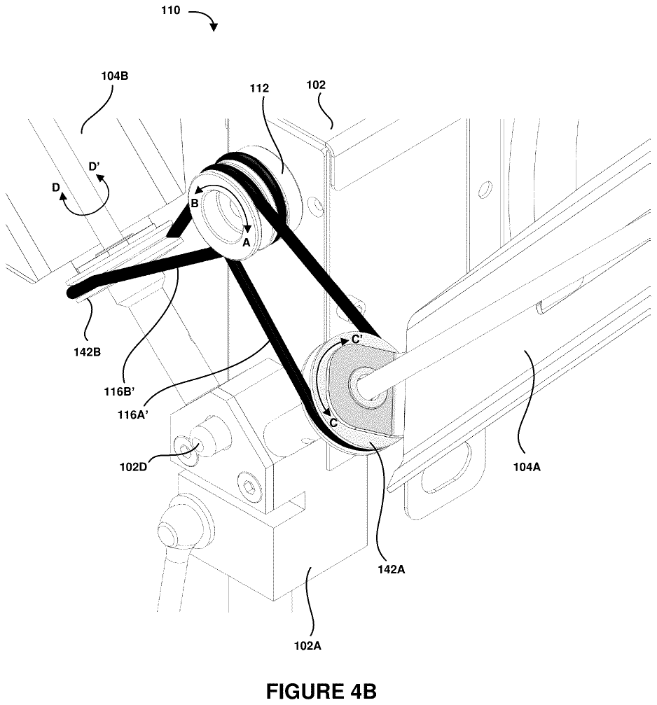

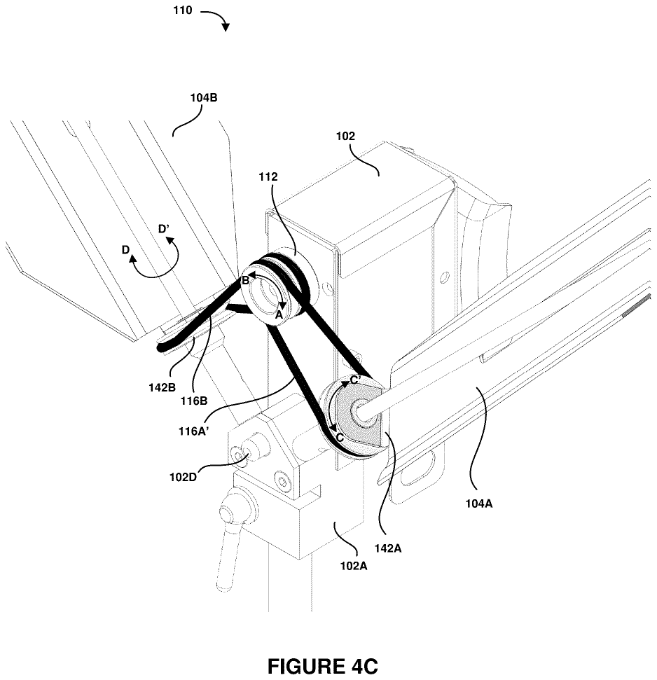

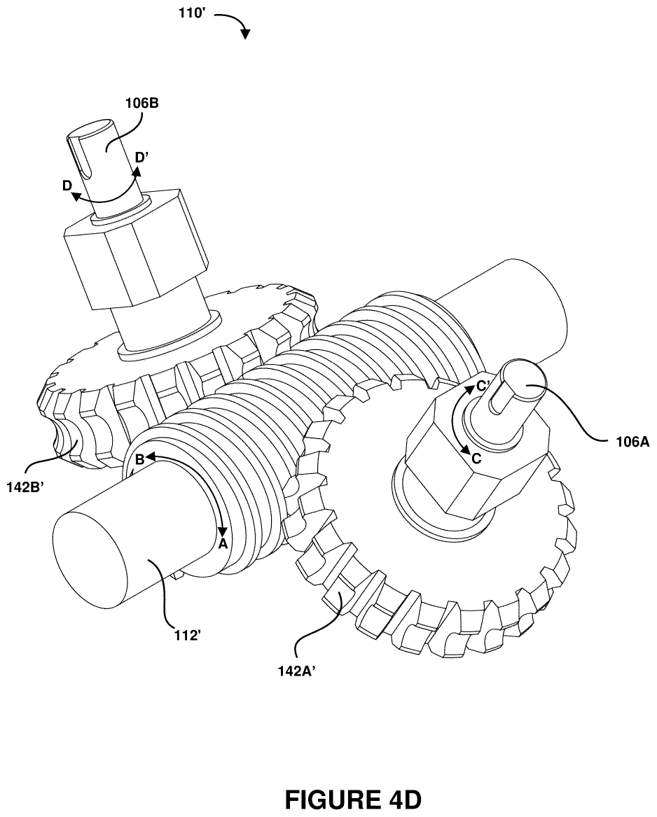

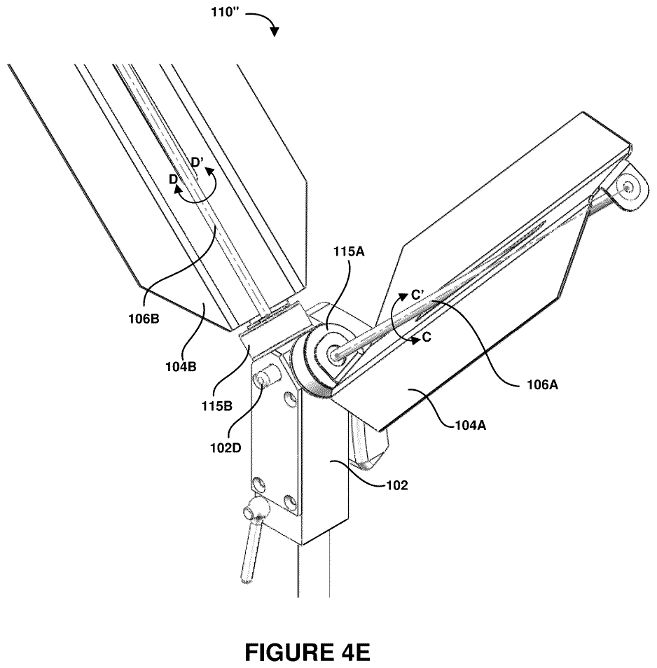

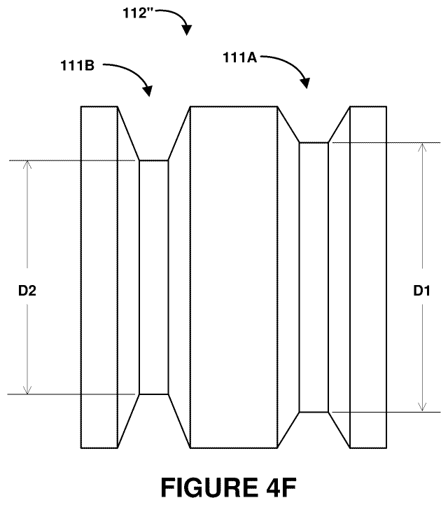

Selecting the drive rate for each wing and each decoy system can be important if multiple decoy systems are deployed in relative close proximity. It has been shown from experimentation, that each decoy system having different wing drive rates attracts more of the selected type of bird species than if all of the decoy systems have the same wing drive rates. The drive mechanism is described in more detail in FIGS. 4A-4F below. It should be noted that as utilized herein the term “about” indicates a range of +/−15 percent of the stated numerical amount.

The waterfowl decoy system 100 also includes a decoy system support 103. The decoy system support can be secured to any suitable support to secure the orientation and/or location of the waterfowl decoy system. By way of example, the decoy system support can secure the waterfowl decoy system to a floating support (not shown) or secure the waterfowls decoy system to a fixed object such as a location on the ground or a bottom of a body of water or other fixed object. In at least one embodiment, the decoy system support includes a pipe or tube that can be secured to the desired support.

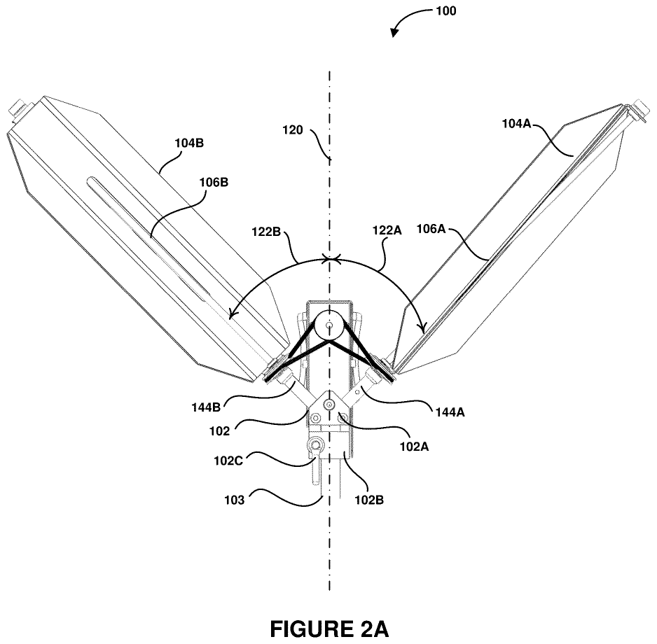

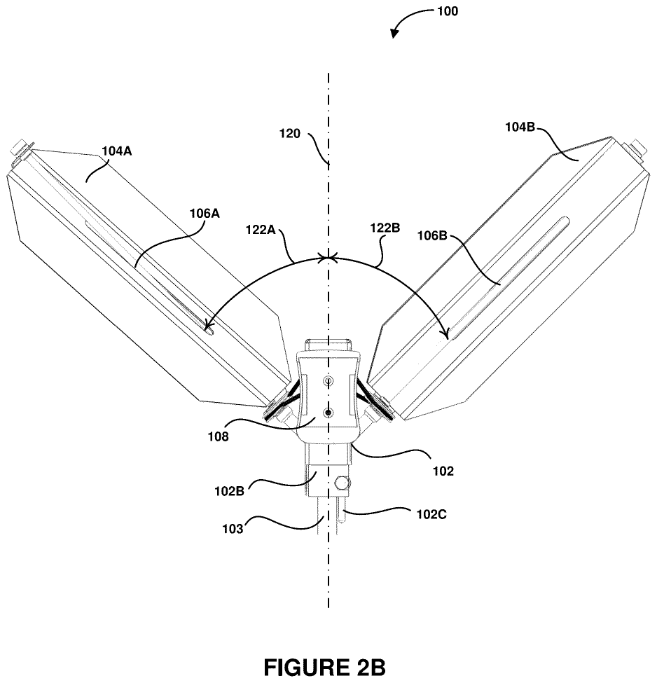

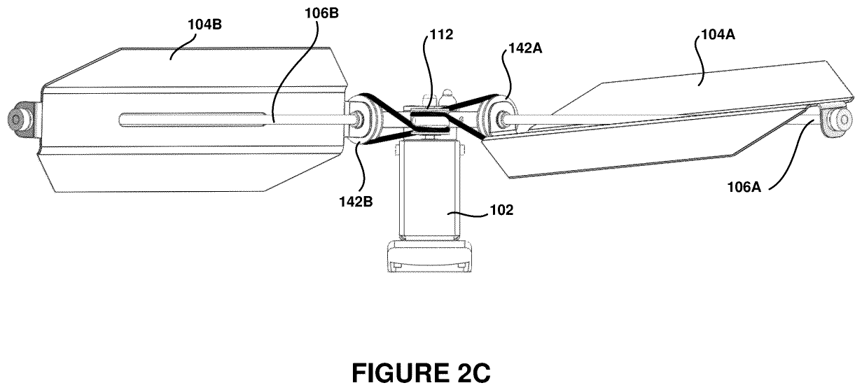

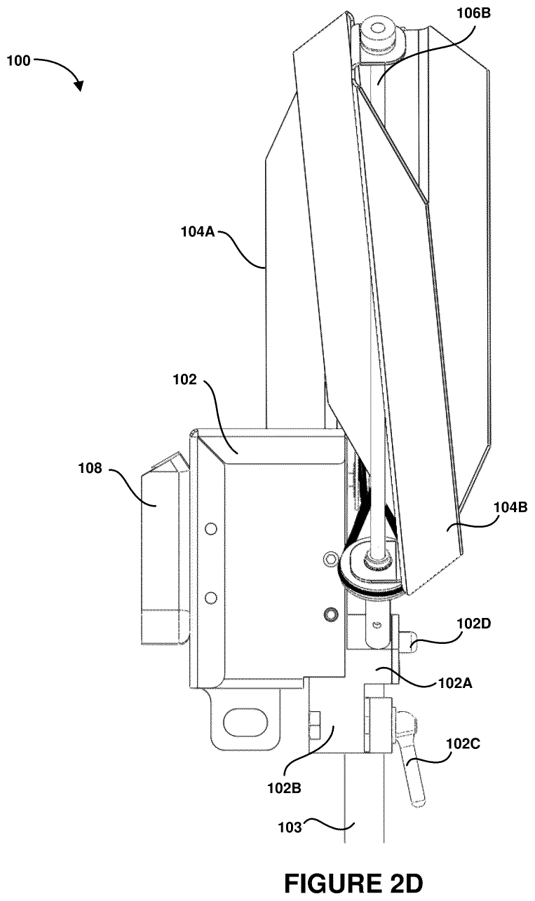

The waterfowl decoy system also includes a clamping block 102B capable of clamping onto the decoy system support 103. As shown in more detail in FIG. 2D below, the clamping block includes a clamping screw 102C capable of compressing the clamping block onto the decoy system support.

The waterfowl decoy system 100 is coupled to a power source 108. The power source can be remotely coupled to the waterfowl decoy system, such as with a wire. Alternatively, the power source can be directly coupled to the central portion 102, as shown in FIG. 1A. In at least one embodiment, the power source includes a battery. In at least one embodiment, the power source includes a commercially available power tool battery so that the user can use a battery from their previously purchased power tools. In at least one embodiment, the power source includes a battery having a first output voltage and a voltage control circuit to reduce the first output voltage to a lower, second voltage for driving the rotation of the wings 104A, 104B. The voltage control circuit provides increased operational time and more efficient use of the battery power and also more precise control of the rotational speed of the wings. By way of example, the battery can have an output voltage of about 18-24 volts and the voltage control circuit reduces the battery output voltage to about 12 volts for powering the wings.

The central portion 102 includes one or more motors and controls to drive the drive wheel 112. The controls can include one or more switches or dial controls to control the rotational speed and direction of the drive wheel. The controls can also provide precise speed control of the one or more motors to allow the wings 104A, 104B to be rotated at similar but at more precise, differing drive rates, as described in more detail herein. By way of example, the one or more motor can include a feedback circuit providing a precise revolutions per minute of the motor to the controls. The feedback circuit allows the control to precisely adjust the motor revolutions to produce a desired drive rate for each of the wings. The controls can also include a receiver capable of receiving control signals from a remote control 133.

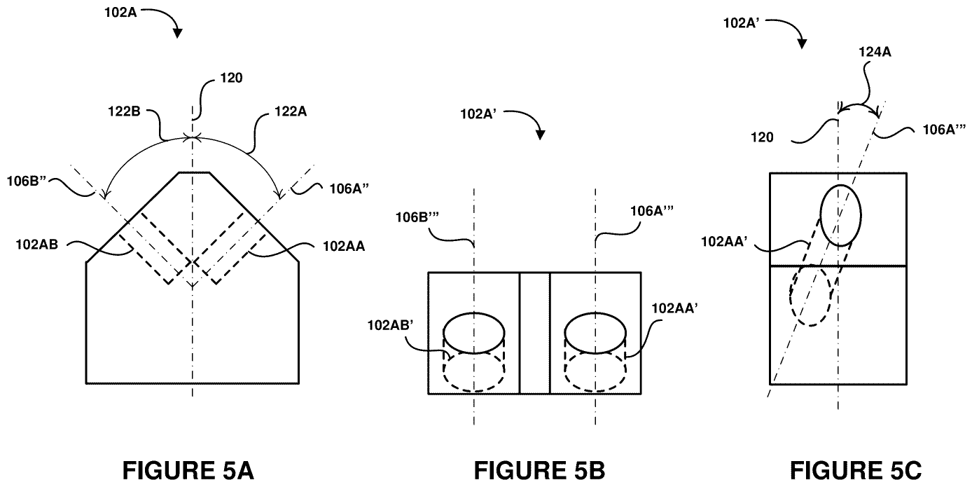

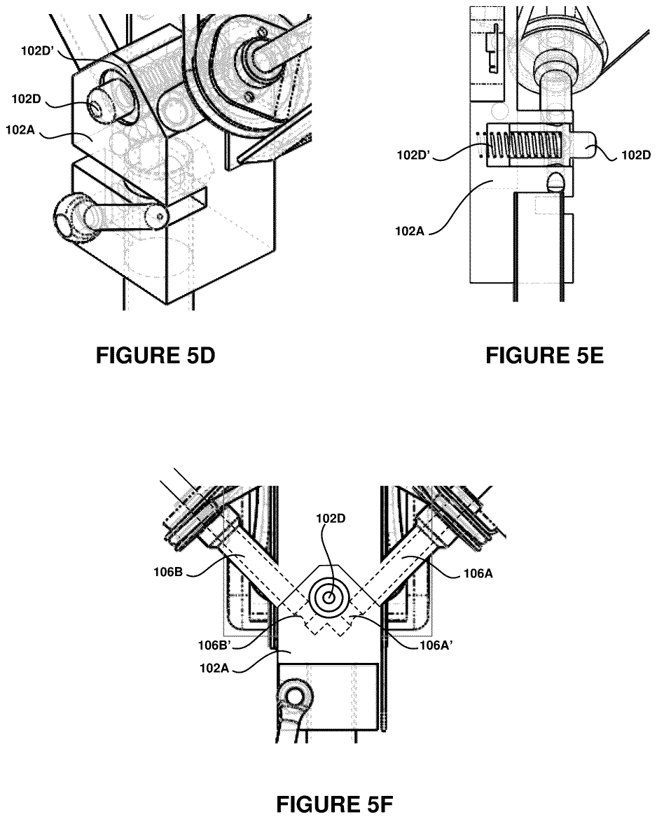

FIG. 1B is an isometric view of an alternative waterfowl decoy system 150, for implementing embodiments of the present disclosure. Similar to the decoy system 100, the decoy system 150 includes a central portion 152, the first wing 104A and the second wing 104B. The decoy system 150 also includes a hydraulic drive mechanism 160 for causing the first wing and the second wing to rotate at the respective first drive rate and second drive rate about the respective first wing axle 106A and the second wing axle 106B. In further similarities to the decoy system 100, the alternative decoy system 150 also includes the first wing and the second wing oriented in adjacent drop angles 122A, 122B with relative to a central axis 170. The hydraulic drive mechanism will be described in more detail in FIG. 5, below.

FIG. 2A is a front view of the waterfowl decoy system 100, for implementing embodiments of the present disclosure. FIG. 2B is a rear view of the waterfowl decoy system 100, for implementing embodiments of the present disclosure. FIG. 2C is a top view of the waterfowl decoy system 100, for implementing embodiments of the present disclosure. FIG. 2D is a side view of the waterfowl decoy system 100, for implementing embodiments of the present disclosure.

The first wing axle is oriented at a first wing drop angle 122A relative to a central axis 120 of the decoy system. The second wing axle is oriented at a second wing drop angle 122B relative to the central axis of the decoy system. The first wing drop angle 122A is adjacent to the second wing drop angle 122B with the central axis being between the first wing drop angle and the second wing drop angle. In at least one embodiment, the first wing drop angle and the second wing drop angle are equal. In an alternative embodiment, the first wing drop angle and the second wing drop angle are not equal. In at least one embodiment, the first wing drop angle and the second wing drop angle are acute angles. In at least one embodiment, the first wing drop angle and the second wing drop angle are between about 25 and about 85 degrees. In at least one embodiment, a sum of the first wing drop angle and the second wing drop angle is less than 180 degrees.

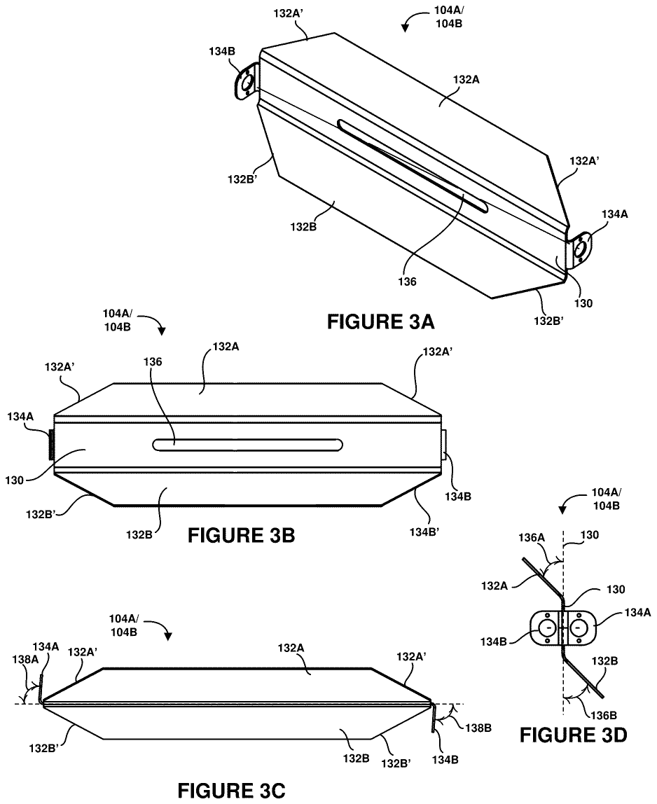

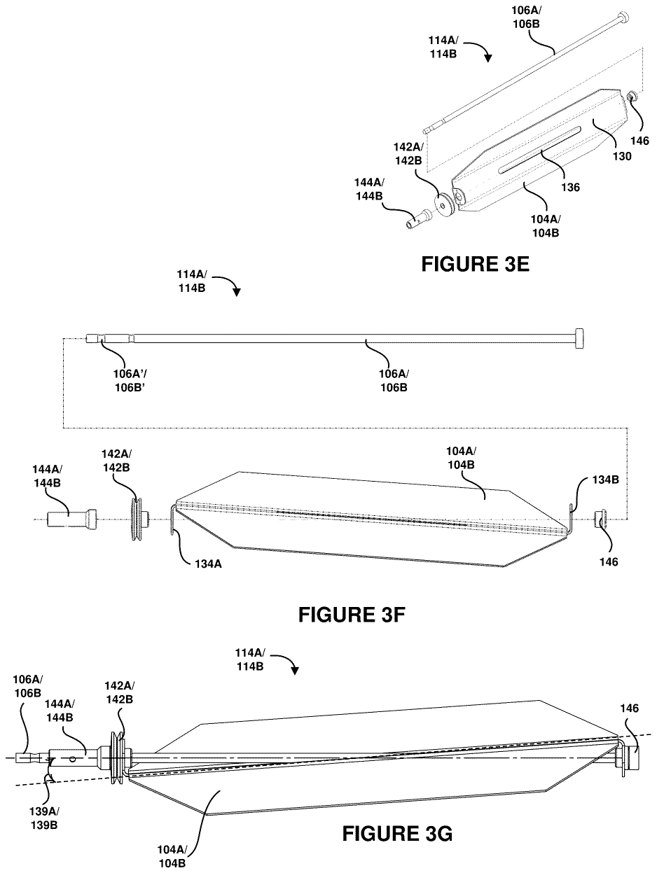

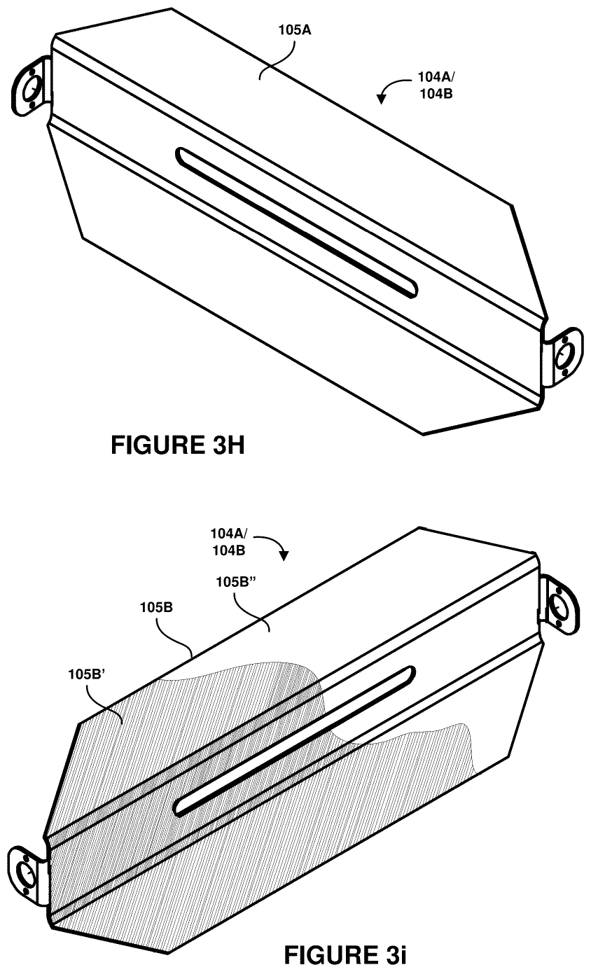

FIGS. 3A-3D are detail views of the wings 104A, 104B, for implementing embodiments of the present disclosure. FIG. 3A is an isometric view of the wings. FIG. 3B is a top surface view of the wings. FIG. 3C is a side view of the wings. FIG. 3D is an end view of the wings. The wings include a central wing portion 130, two flap portions 132A, 132B formed along corresponding sides of the central wing portion.

The flap portions include optional, tapered end portions 132A′, 132B′. The tapered end portions can be tapered at an angle between about 20 degrees and about 60 degrees. The flap portions are bent to form respective angle 136A, 136B of between about 20 degrees and about 45 degrees to a plane 130A of the flat central wing portion, with a first flap portion being bent upward from the central wing portion and a second flap portion being bent downward from the central wing portion. It should be understood that the descriptions of the flap portions, wing lengths, wing widths and overall wing shape are provided as examples and that the shape, width, length and flap angles are to be selected as more closely appearing similar to the bird species desired to be attracted.

The wings also include a first wing axle support tab 134A and a second wing axle support tab 134B. The first wing axle support tab 134A is bent upward at a first wing axle support tab angle 138A from the plane 130A of the flat central wing portion. The second wing axle support tab 134B is bent downward at a second wing axle support tab angle 138B from the plane of the flat central wing portion. The central portion also includes an axle pass-through slot 136, as described in more detail in FIGS. 3E-3G.

FIGS. 3E-3G are detail views of the wing assemblies 114A, 114B, for implementing embodiments of the present disclosure. The wing assemblies include the wings 104A, 104B, the wing axle 106A, 106B, a wing drive wheel 142A, 142B, an optional spacer 144 and a support bushing 146.

The axle 106A, 106B passes through a proximal wing axle support tab 134A, then through the wing axle pass-through slot 136 in the central wing portion 130 and into a distal wing axle support tab 134B to form a wing axle offset rotational angle 139A, 139B to the plane 130A of the central wing portion. The support bushing 146 supports the axle in the second wing axle support tab. The wing axle offset rotational angle 139A, 139B adds to lifelike-appearing motion of the wings 104A, 104B, when the wing is rotated about the wing axle.

The wing drive wheel 142A, 142B can include a drive wheel bushing 142A′, 142B′ to support the wing axle within the first wing axle support tab. The wing drive wheel is also secured to the first wing axle support tab such that rotating the drive wheel will also rotate the wing. The optional spacer 144 provides a desired spatial alignment of the wing drive wheel to a drive wheel 112 of the central portion 102 of the decoy system 100. In one embodiment, the wing drive wheels 142A, 142B can have an equal diameter. In another embodiment, the wing drive wheels 142A, 142B can have different diameters.

The size of wing axle offset rotational angle 139A, 139B is a function of a desired offset of the wing axle from the plane 130A of the central wing portion and determined by a length of the first wing axle support tab and the second wing axle support tab and the overall wing length. In one embodiment, the wing axle offset rotation angle is between about 3 degrees and about 10 degrees.

In another exemplary embodiment, the wing axle offset rotation angle is 4 degrees with the first wing axle support tab and the second wing axle support tab spacing the wing axle about ½ inch (13 mm) and the wing having a length of about 13 inches (325 mm). In at least one embodiment, the first wing axle support tab angle 138A and the second wing axle support tab angle 138B are equal to a sum of 90 degrees plus wing axle offset rotational angle 139A, 139B.

It should be understood that the respective wing lengths and spacing provided by the first wing axle support tab and second wing axle support tab are for example embodiment purposes only and should not be considered limiting as the wing length may vary from relatively short length of between about 6 inches (150 mm) and about 36 inches (900 mm) corresponding to a wing of the desired waterfowl or other types of birds. Similarly, the first wing axle support tab and second wing axle support tab can be sized to space the wing axle away from the central portion of the wing form a corresponding, desired wing axle offset rotation angle.

Similar to the wing length, a wing width is corresponds to wings of the desired waterfowl or other types of birds, that may be attracted to the decoy. In at least one exemplary embodiment, the wing length can be about 13 inches (325 mm) and the wing width can be about 5 inches (125 mm). In other embodiments the wing width and the wing length and any ratio of the wing width can be adjusted to attract the desired waterfowl or other types of birds.

It should be understood that while the illustrated wings are formed from sheet materials, the wings could also be formed from metal, composite, plastic or polystyrene or similar materials that would allow the wings to have an even more realistic shape, width, length, thickness, rounded edges and pointed tips and tapered end proportions and combinations thereof to more effectively mimic the desired bird species.

The support bushings 146 and the drive wheel bushings 142A′, 142B′ can be formed of any suitable materials. Example materials include PTFE, nylon, polyoxymethylene, or other suitable plastic type materials and/or metal bushings. The support bushings and drive wheel bushings can include roller, needle or ball bearings or combinations thereof.

The wing axles 106A, 106B can include latching slots 106A′, 106B′ that provide the function of quick release and quick assembly by engaging the wing quick release button 102D in the wing support block 102A. The wing assemblies can be inserted into the first wing axle socket 102AA and a second wing axle socket 102AB of the wing support block. The wing quick release button 102D can be depressed into the wing support block to allow the wing axle to settle into the first wing axle socket and a second wing axle socket. Releasing the wing quick release button causes the wider portion of the button to pass through the latching slots 106A′, 106B′ which prevents the wing axles from being withdrawn from the wing support block. The wing quick release button in the wing support block allows ease of assembly and disassembly of the wings to the central portion 102.

FIGS. 3H-3i are detail views of the wing 104A, 104B, for implementing embodiments of the present disclosure. The wing includes a wing top surface 105A and wing bottom surface 105B. The wing bottom surface is opposite from the wing top surface. In at least one embodiment, the wing top surface is covered in a first wing color and the wing bottom surface is covered in a second wing color. The first wing color can be a relatively bright color such as white or silver or other bright colors and shades thereof, such that the first wing color reflects a majority of wavelengths of light that impend thereon. In sharp contrast, the second wing color is a relatively dark color such as brown, black, blue, purple or combinations thereof, such that the second wing color absorbs a majority of wavelengths of light that impend thereon. The second wing color can cover an entire second surface of the wing or merely one or more wing surface portions 105B′, 105B″ of the second surface. Similarly, wing surface portions 105B′, 105B″ can be different colors or shades.

The contrasting colors of the first wing color and the second wing color adds to the lifelike-appearing motion of the wings 104A, 104B, when the wing is rotated about the wing axle. Further, the contrasting colors of the first wing color and the second wing color causes the wing to appear to flash alternating bright and then dark, when viewed from a distance, such as a distance across a body of water or fields or flying overhead at an altitude. By way of example, where a distance between a viewer (e.g., a desired bird) and the decoy can be between about 100 feet (30 meters) to about 4000 feet (1200 meters).

The first wing color and the second wing color can be applied by any acceptable means. By way of non-limiting examples, the colors may be applied by one or more of by painting or anodizing or powder coating or wrapping with a plastic sheet of the desired color, or any other acceptable means to apply the desired colors to the wings. In another example, the colors could be the base colors of the material of the wing. By way of example, in an embodiment where the wing is formed from one or more aluminum sheets and bent and trimmed to the desired size and shape, the bright color could be the substantially bare surface of the aluminum or the bare surface with a clear protective coating. In another embodiment, the wing could be made from a plastic or composite and one or both of the desired colors could be included in the plastic or composite resin. Combinations of the color application strategies described herein could also be utilized.

FIG. 4A is a detail view of a drive mechanism 110, for implementing embodiments of the present disclosure. The drive mechanism includes a drive wheel 112 driven by a motor (not shown) disposed within the central decoy portion 102. As described above, each of the wings 104A, 104B include a wing drive pulley 142A, 142B. The wing drive pulleys are mechanically coupled to the drive wheel. As illustrated the mechanical coupling is a belt 116A, 116B, however, similar mechanical couplings such as a chain or toothed belt or wound metal “spring” type drive belt or other similar mechanical couplings could also be used. The material of the belt 116A, 116B can be any suitable material such as a flexible o-ring material or a flexible metal band similar to a tightly wound spring or a flexible plastic or polyurethane, rubber, silicon, nitrile, ethylene propylene diene monomer (EPDM) or combinations thereof. In one exemplary embodiment the o-ring material includes hydrogenated nitrile butadiene rubber (HNBR) One or more support fibers can also be included within the o-ring material.

The belt 116A, 116B provides many optional drive methods. By way of example, as shown, as the drive wheel 112 rotates in a clockwise direction A, the wing drive wheel 142A and the first wing 104A will rotate in direction C. Similarly, as the drive wheel 112 rotates in a clockwise direction A, the wing drive wheel 142B and the second wing 104A will rotate in a direction D. Similarly, reversing the drive wheel rotation in a counterclockwise direction B, will drive the first wing in direction C′ and the second wing in direction D′. A user can select the routing of the belts 116A, 116B to select the corresponding direction of rotation for each of the wings, as the decoy system is assembled in the field.

FIG. 4B is a detail view of a drive mechanism 110, for implementing embodiments of the present disclosure. As shown, the belts 116A′, 116B′ are routed opposite from the routing shown in FIG. 4A. The reverse routing reverses the direction of the wings as described above such as in an embodiment where the drive wheel 112 only rotates in one direction such as only in clockwise direction A or only in counterclockwise direction B. The routing flexibility of the belts allows the user to choose the direction of rotation of each of the wings 104A, 104B.

FIG. 4C is a detail view of a drive mechanism 110, for implementing embodiments of the present disclosure. As shown, the belt 116B is routed as shown above, in FIG. 4A and the belt 116A′ routed as shown in FIG. 4B, thus allowing the user to drive the wings in opposite directions of rotation, such as wing 104A rotating in direction C and wing 104B rotating in direction D′.

FIG. 4D is a detail view of a worm drive mechanism 110′, for implementing embodiments of the present disclosure. The drive mechanism includes a worm gear set including drive worm gear 112′ and wing worm drive wheels 142A′, 142B′. The drive worm gear is driven by a motor within the central decoy portion (not shown). As the drive worm gear rotates, the teeth of the drive worm gear engages with the teeth of the wing worm drive wheels causing the wing worm drive wheels and the corresponding wing axles 106A, 106B and the wings attached thereto to rotate in corresponding directions.

The embodiments described in FIGS. 4A-4D allow the rotational rate, e.g., revolutions per minute, of the wings 104A, 104B to be selected in two methods. In a first method, the revolutions per minute of the drive wheel 112 or worm drive gear 112′ will drive the revolutions per minute of the wing drive wheels 142A, 142B and wing worm drive wheels 142A′, 142B′ such that varying the revolutions per minute of the drive wheel or drive gear will correspondingly vary the revolutions per minute of both of the wings 104A, 104B the same amount.

In a second method, the revolutions per minute of the drive wheel 112 or drive gear 112′ determines the corresponding revolutions per minute of the mechanically coupled wings 104A, 104B by way of the ratio of the diameter of the drive wheel 112 to the diameter of the wing drive wheels 142A, 142B. Similarly, the ratio of the diameter of the drive gear 112′ to the diameter of the wing worm drive wheels 142A′, 142B′ determines the corresponding revolutions per minute of the wings. By way of example, if the ratio of the diameter drive wheel or worm drive gear to the diameter of the wing drive wheels or wing worm drive wheels determine the revolution per minute of the wings. A lower ratio causes the wings to rotate and a lower rate than the drive wheel or worm drive gear. Similarly, a greater ratio will result in the rotating at a faster revolutions per minute than the revolutions per minute of the drive wheel and worm drive gear, respectively.

FIG. 4E is a detail view of a drive mechanism 110″, for implementing embodiments of the present disclosure. The embodiments described in FIGS. 4A-4D include a single drive wheel 112 to drive both wings 104A, 104B. The single drive wheel 112 is driven by a motor within the central decoy portion 102. In contrast, the drive mechanism 110″ includes corresponding drive motors 115A, 115B directly driving the respective wings 104A, 104B. The separate drive motors allows the user to select desired revolutions per minute and direction of rotation of each of the wings.

FIG. 4F is a detail view of a drive wheel 112″, for implementing embodiments of the present disclosure. The drive wheel 112, 112″ includes two grooves 111A, 111B for gripping and driving the corresponding belts 116A, 116B. In an alternative embodiment, the single drive wheel 112″ can include two different diameter grooves 111A′, 111B″ thus providing a different revolutions per minute of each of the wings, from a single revolution per minute of the drive wheel 112″.

By way of example, if the groove 111A′ has a diameter D1 of 1.0 inch (25 mm) and the groove 111B′ has a diameter D2 of 0.78 inch (20 mm) and the wing drive wheels 142A, 142B both have a diameter of 1.0 inch (25 mm) then the wing driven by belt 116B will rotate at an equal revolutions per minute as the drive wheel 112″ and the wing driven by belt 116A will rotate at a 0.78 of the revolutions per minute as the drive wheel. The drive wheel 112″ allows the user to select differing revolutions per minute and same or different directions of rotation for each of the wings 104A, 104B, while only requiring a single drive motor. In at least one embodiment, the diameter of groove 111A′ is about 3 percent larger than the diameter of the groove 111B′ resulting in the wings having revolutions per minute of about 3 percent different. In at least one embodiment, multiple drive wheels with different diameter grooves can be provided and the drive wheel with the desired drive diameter grooves can be selected and installed to provide the desired rate of rotation for each of the wings.

FIG. 5A is a detail views of a wing support block 102A, for implementing embodiments of the present disclosure. The first wing drop angle 122A and the second wing drop angle 122B are determined by the shape of a wing support block 102A. By way of example, the wing support block includes a first wing axle socket 102A′ and a second wing axle socket 102A″. The first wing axle socket 102A′ and a second wing axle socket 102A″ are angularly offset from the central axis 120 by the first wing drop angle and the second wing drop angle, respectively. In at least one embodiment, a first wing support block can be replaced with a second wing support block having different first wing drop angle and second wing drop angle.

FIGS. 5B-5C are detail views of a wing support block 102A′, for implementing embodiments of the present disclosure. The wing support block includes first wing axle socket 102AA and a second wing axle socket 102AB. The first wing axle socket has a centerline 106A′″ and the second wing axle socket has a centerline 106B′″. The first wing axle socket 102AA and a second wing axle socket 102AB are separated from the centerline 120 by corresponding sweep angles 124A and 124B (not shown). The sweep angles cause the wings to be swept backward on the decoy system. Sweep angles that appear more similar to a desired bird species can more accurately represent and attract the desired bird species.

FIGS. 5D-5F are detail views of a wing quick release button 102D, for implementing embodiments of the present disclosure. The wing release button is spring loaded by spring 102D′ and when depressed, allow the wing axles to be inserted into the first wing axle socket 102AA and a second wing axle socket 102AB. Releasing the wing quick release button causes the wider portion of the button to pass through the latching slots 106A′, 106B′ which prevents the wing axles from being withdrawn from the wing support block.

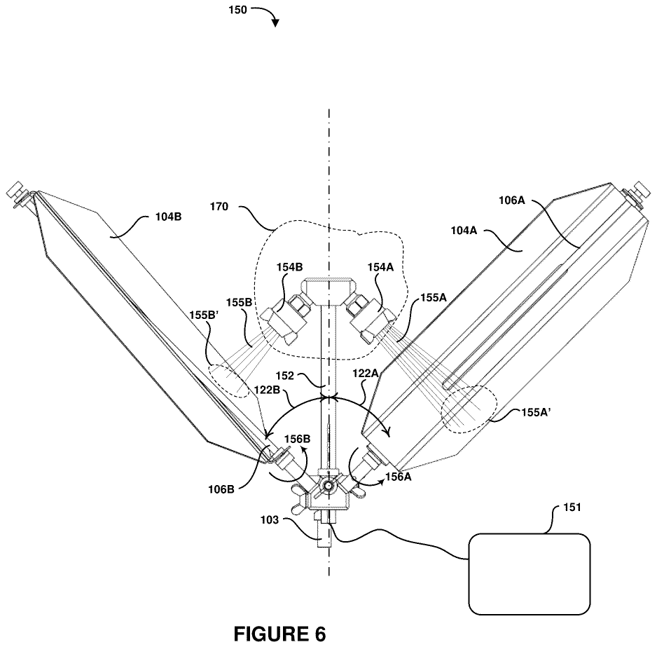

FIG. 6 is a detail view of a hydraulic drive mechanism 170, for implementing embodiments of the present disclosure. The hydraulic drive mechanism includes a pressurized hydraulic fluid supply source 151 coupled to a fluid delivery portion 152. At least two nozzles 154A, 154B are fluidly coupled to the fluid delivery portion. The at least two nozzles are adjusted to emit corresponding fluid jets 155A, 155B at a selected flow rate, toward the wings. The selected fluid flow rate corresponds to desired revolutions per minute of the wings. A slower fluid flow rate results in a slower revolutions per minute of the wing. Conversely, a faster fluid flow rate results in a faster revolutions per minute of the wing. The flow rate through the nozzles can be selected by adjusting a variable nozzle opening or installing a flow controlling device, such as a orifice, upstream of each of the nozzles.

The at least two nozzles are aimed at corresponding wings 104A, 104B and more precisely, the nozzles are aimed to direct the fluid jets 155A, 155B toward selected portions of the wings 155A′, 155B′ either forward of the wing axles 106A, 106B or aft of the wing axles. By way of example, fluid jet 155A is directed to a portion 155A′ of wing 104A where portion 155A is forward of the wing axle 106A, causing wing 104A to rotate in direction 156A. Similarly, fluid jet 155B is directed to a portion 155B′ of wing 104B where portion 155B is aft of the wing axle 106B, causing wing 104B to rotate in direction 156B. Selecting the desired portions of the wings the fluid jets are directed to impinge allows the user to select the wing rotation direction.

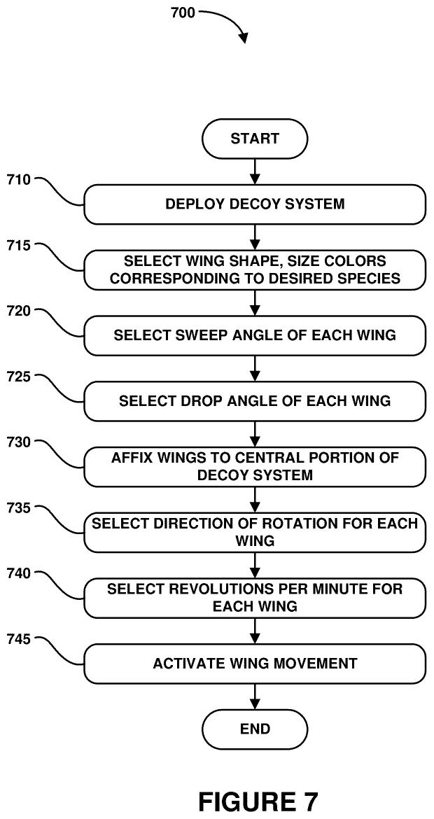

FIG. 7 is a flowchart diagram that illustrates the method operations 600 performed in flashing the wing assemblies of a waterfowl decoy system 100, 150, for implementing embodiments of the present disclosure. The operations illustrated herein are by way of example, as it should be understood that some operations may have sub-operations and in other instances, certain operations described herein may not be included in the illustrated operations. With this in mind, the method and operations 600 will now be described.

In an operation 710, a decoy system 100/150 is deployed in a selected area to attract a desired a bird species. The size, colors and speed of the wings correspond to the bird species desired to be attracted. In at least one embodiment, the wings have a bright color on a bottom surface and a dark color on a top surface. Deploying the decoy system can also including securing the decoy system in a selected location and orientation and whether the selected location is fixed or movable such as secured to a floatation device or a device that allows the decoy system to rotate.

In an operation 715, a wing shape, size, color are selected that correspond to the desired bird species.

In an operation 720, a desire wing sweep angle is selected.

In an operation 725, select the drop angle of each wing relative to the center line of the central decoy portion. The selected drop and sweep angles are typically selected as one that seems to appear more lifelike to the selected bird species. Selecting the drop and sweep angles can include selecting and installing a wing support block having the selected drop and sweep angles for each wing.

In an operation 730, the wings are affixed to the central portion of the decoy system by inserting the wing axles into the wing support block.

In an operation 735, the desired direction of rotation of each wing are selected. The direction of rotation of the wing about the wing axle can be selected as described in more detail above. In at least one embodiment, the wings can have the same direction of rotation. In an alternative embodiment, the wings can have different directions of rotation. The selected direction of rotation of each of the wings cause the wings to appear to be substantially lifelike wing flapping to the desired bird species.

In an operation 740, the desired drive rates of each wing are selected. The drive rate for the wing corresponds to the desired revolutions per minute of the wing, as the wing rotates around the wing axle. In at least one embodiment, the wings can have the same drive rates and directions. In an alternative embodiment, the wings can have different drive rates or directions. In another embodiment, the wings can have varying drive rates. The selected revolutions per minute of the wings appear to be substantially lifelike wing flapping to the desired bird species.

In an operation 745, the selected direction and rotation rate of movement of the wings is activated to cause the wings to appear to flap from a distance. In at least one embodiment, where the wings have a bright color on a bottom surface and a dark color on a top surface, the rotating wings appear to repeatedly alternate flashing bright and then going dark. The flashing wings appear substantially lifelike to the desired bird species. Then the operations can end.

Although the foregoing disclosure has been described in some detail for purposes of clarity of understanding, it will be apparent that certain changes and modifications may be practiced within the scope of the appended claims. Accordingly, the present embodiments are to be considered as illustrative and not restrictive, and the disclosure is not to be limited to the details given herein, but may be modified within the scope and equivalents of the appended claims.

What is claimed is:

1. An animated waterfowl decoy system comprising:
a central decoy portion including:
a drive mechanism; and
a central axis passing vertically through the central decoy portion;
a first wing assembly including:
a first wing axle secured to the central decoy portion at a first wing drop angle relative to the central axis; and
a first wing rotatably mounted on the first wing axle, the first wing being mechanically coupled to the drive mechanism at a first drive rate; and
a second wing assembly including:
a second wing axle secured to the central decoy portion at a second wing drop angle relative to the central axis, the second wing drop angle being adjacent to the first wing drop angle; and
a second wing rotatably mounted on the second wing axle, the second wing being mechanically coupled to the drive mechanism at a second drive rate, wherein the first drive rate is not equal to the second drive rate.

2. The system of claim 1, wherein the first wing includes a first wing top surface and first wing bottom surface, wherein the first wing bottom surface is opposite from the first wing top surface, and the second wing includes a second wing top surface and second wing bottom surface, wherein the second wing bottom surface is opposite from the second wing top surface and wherein the first wing top surface and the second wing top surface are covered in a first wing color and the first wing bottom surface and the second wing bottom surface are covered in a second wing color.

3. The system of claim 2, wherein the first wing color is a substantially white color and wherein the second wing color is a relatively dark shade of at least one of brown, black, blue or a combination thereof.

4. The system of claim 1, wherein the drive mechanism is electrically powered.

5. The system of claim 1, wherein the drive mechanism is hydraulically powered.

6. The system of claim 5, wherein the hydraulically powered drive mechanism includes:
a first hydraulic jet aimed at the first wing, the first hydraulic jet being sized to spray a first hydraulic flow rate of fluid toward and impending on the first wing to cause the first wing to rotate about the first wing axle at the first drive rate; and
a second hydraulic jet aimed at the second wing, the second hydraulic jet being sized to spray a second hydraulic flow rate of fluid toward and impending on the second wing to cause the second wing to rotate about the second wing axle at the second drive rate.

7. The system of claim 1, wherein the first wing drop angle is between 25 and 85 degrees and the second wing drop angle is between 25 and 85 degrees.

8. The system of claim 1, wherein the first wing drop angle and the second wing drop angle are not equal.

9. The system of claim 1, wherein the first wing drop angle and the second wing drop angle are equal.

10. The system of claim 1, wherein a sum of the first wing drop angle and the second wing drop angle is less than 180 degrees.

11. The system of claim 1, wherein the first wing axle extends from a first wing top surface of the first wing, passing through a first central wing portion to a first wing bottom surface of the first wing at a first wing axle offset rotational angle relative to a first central wing portion plane, and wherein the second wing axle extends from a second wing top surface of the second wing, passing through a second central wing portion to a second wing bottom surface of the second wing at a second wing axle offset rotational angle relative to a second central wing portion plane.

12. The system of claim 11, wherein the first wing axle offset rotational angle is not equal to the second wing axle offset rotational angle.

13. The system of claim 1, wherein the first wing being mechanically coupled to the drive mechanism with a belt.

14. The system of claim 1, wherein the first wing being mechanically coupled to the drive mechanism with a chain.

15. The system of claim 1, wherein external drive wheel includes an outer drive wheel perimeter surface and a first wing wheel is coupled to the first wing and includes a first wing wheel outer perimeter surface, wherein the outer drive wheel perimeter surface frictionally contacts first wing wheel outer perimeter.

16. The system of claim 1, wherein the first drive rate and the second drive rate are between 250 and 410 revolutions per minute.

17. The system of claim 1, wherein the first drive rate is within 3 percent of the second drive rate.

18. An animated waterfowl decoy system comprising:
a central decoy portion including a drive mechanism coupled to an external drive wheel through a drive axle;
a first wing assembly including:
a first wing body having a first proximal wing end, a first distal wing end and a first central wing portion disposed between the first proximal wing end and the first distal wing end;
a first wing axle having:
a first proximal end and a first distal end opposite the first proximal end, the first proximal end being secured to the central decoy portion at first wing drop angle relative to a central axis of the central decoy portion; and
the first proximal wing end being rotationally secured to the first wing axle adjacent to the first proximal end and the first distal wing end being rotationally secured to the first wing axle at the first distal end; and
a first wing wheel secured to the first proximal wing end, the first wing wheel being mechanically coupled to the external drive wheel at a first drive rate.

19. The system of claim 18, further comprising:
a second wing assembly including:
a second wing body having a second proximal wing end, a second distal wing end and a second central wing portion disposed between the second proximal wing end and the second distal wing end;
a second wing wheel secured to the second proximal wing end, the second wing wheel being mechanically coupled to the external drive wheel; and
a second wing axle having:
a second proximal end and a second distal end opposite the second proximal end, the second proximal end being secured to the central decoy portion at a second wing drop angle relative to the central axis of the central decoy portion, wherein the first wing drop angle is less than 90 degrees and the second wing drop angle is less than 90 degrees;
the second proximal wing end being rotationally secured to the second wing axle adjacent to the second proximal end and the second distal wing end being rotationally secured to the second wing axle at the second distal end; and
a second wing wheel secured to the second proximal wing end, the second wing wheel being mechanically coupled to the external drive wheel at a second drive rate, wherein the first drive rate is not equal to the second drive rate.

20. The system of claim 19, wherein the first wing top surface and the second wing top surface are covered in a first wing color and the first wing bottom surface and the second wing bottom surface are covered in a second wing color, wherein the first wing color is a substantially white color and wherein the second wing color is a relatively dark shade of brown, black, blue and combinations thereof.
